(19) United States
(12) Patent Application Publication
(10) Pub. No.: US 2011/0146159 A1
(43) Pub. Date: Jun. 23, 2011

(54) Shaft Structure

(75) Inventors: Lin ZHANG, Shanghai (CN); Ai-Min LI, Shanghai (CN); Pondersen SHEN, Taipei County (TW)

(73) Assignee: INVENTEC APPLIANCES CORP., Taipei County (TW)

(21) Appl. No.: 12/732,612

(22) Filed: Mar. 26, 2010

(30) Foreign Application Priority Data
Dec. 23, 2009 (TW) 098224152

(51) Int. Cl. E05D 3/02; E05D 11/08; E05D 11/10; F16C 11/10; E05C 19/00

(52) U.S. Cl. 49/394; 16/341; 16/327

(57) ABSTRACT

The invention discloses a shaft structure comprising a fixing part and a braking part, and both the fixing part and the braking part are disposed in a housing. The fixing part comprises a plurality of first protruding part and a plurality of concave part formed between any two adjacent first protruding parts. The braking part comprises a plurality of flexible second protruding part, and each second protruding part leans against to one of the concave parts. The braking part can be fixed in a specific angle relative to the fixing part after the braking part rotating along with the fixing part by crossing each of the second protruding part over the first protruding part and leaning against the adjacent concave part.

### FIELD OF THE INVENTION

The present invention relates to a shaft structure, and more particularly to a shaft structure which can be fixed at an arbitrary angle.

### BACKGROUND OF THE INVENTION

Nowadays, various common electronic devices are provided with flip covers, such that when the electronic device is not in use, the user can close the flip cover to protect the screen of the electronic device. However, the flip cover function of current electronic devices is very simple, namely, the flip cover only has a function of protecting the screen when an electronic device is not in use, and is idle during the period when the user uses the electronic device. Therefore, there exists the problem that the screen cannot be seen clearly in strong light conditions during the period when the user uses the electronic device. Furthermore, if it is desired to keep the electronic device inclined toward the desk top during the period when the user uses the electronic device, the problem of no suitable supports will occur.

### SUMMARY OF THE INVENTION

In view of the aforementioned problems of the prior art, an object of the present invention is to provide a shaft structure, so as to solve the problem that a shaft structure for a flip cover of an electronic device or an article with a flip cover cannot serve as a light-shielding plate to shield strong light during the period when the user uses the electronic device; or to solve the problem that a shaft structure cannot serve as a support to keep an electronic device inclined toward the desk top during the period when the user uses the electronic device.

According to the object of the present invention, a shaft structure is provided comprising a fixing part and a braking part. The fixing part is disposed in a housing, and the fixing part comprises a plurality of first protruding parts and a plurality of concave parts formed between any two adjacent first protruding parts; the braking part extends from the housing toward the fixing part and is disposed around the fixing part, and comprises a plurality of second protruding parts, and each of the second protruding parts leans against to one of the concave parts.

When the braking part is rotated, each of the plurality of flexible second protruding parts is crossed over the first protruding part and leans against the adjacent concave part. At this time, each second protruding part can be fixed at this rotating angle which is determined by the number of the first protruding parts of the fixing part.

According to the object of the present invention, a flip-cover apparatus is further provided comprising a body, a cover, and a shaft structure. The shaft structure is connected to the body and the cover, and comprises a housing, a fixing part, and a braking part. The fixing part is disposed in the housing, and comprises a plurality of first protruding parts and a plurality of concave parts formed between any two adjacent first protruding parts. The braking part extends from the housing toward the fixing part and is disposed around the fixing part, and comprises a plurality of second protruding parts. When the body and the cover are in an open state, each of the second protruding parts is configured to leans against to one of the concave parts.

As described above, the shaft structure according to the present invention may have one or more of the following advantages:

(1) The second protruding parts lean against the concave parts so that the shaft structure can be fixed at a specific angle.

(2) The angle through which the shaft structure is rotated each time can be determined by the number of the first protruding parts of the fixing part.

(3) The shaft structure can be fixed at a specific angle and combined with a flip-cover structure to achieve the effects of shielding strong light and supporting the device.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic view of a flip-cover apparatus according to the present invention;

FIG. 2 is one embodiment of a schematic view of a shaft structure according to the present invention;

FIG. 3 is another embodiment of a schematic view of a shaft structure according to the present invention; and

FIG. 4 is a simulation diagram illustrating an operation of a flip-cover apparatus according to the present invention.

### DETAILED DESCRIPTION OF THE PREFERRED EMBODIMENTS

Exemplary embodiments of the present invention are described herein in the context of shaft structure.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

Embodiments of the shaft structure according to the present invention will be described below with reference to the related drawings. For the convenience of understanding the description, the same elements in the embodiments will be given the same reference numerals.

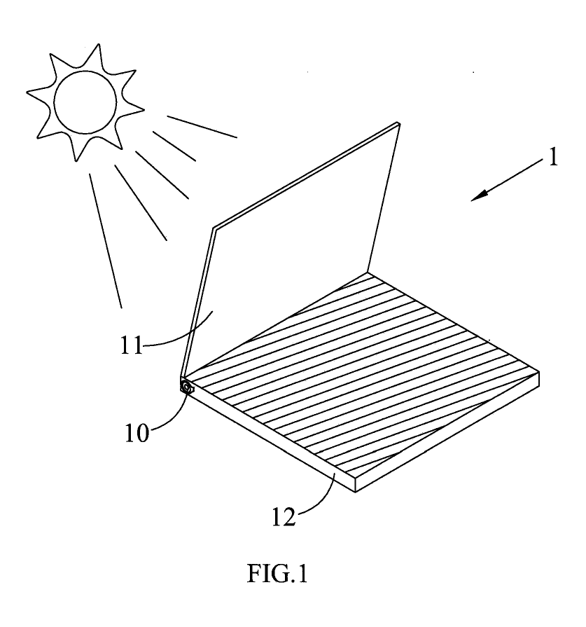

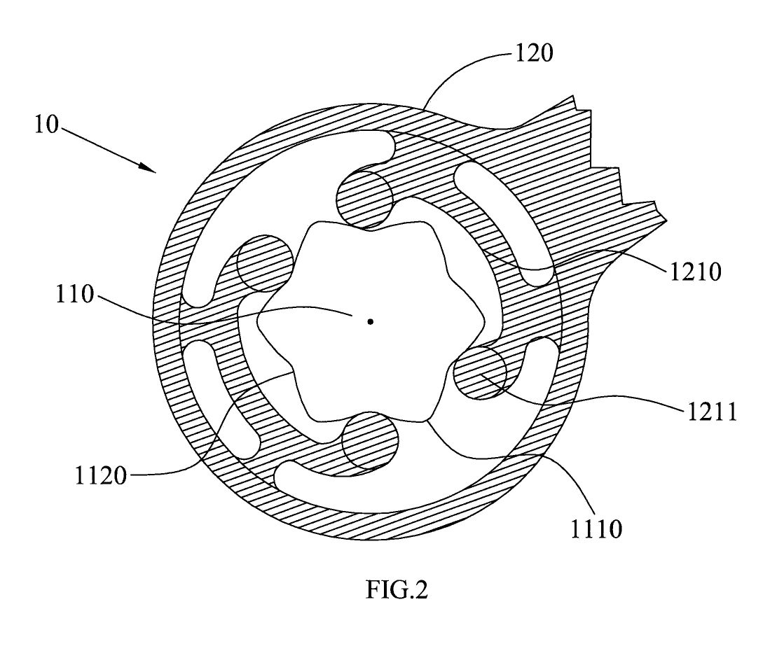

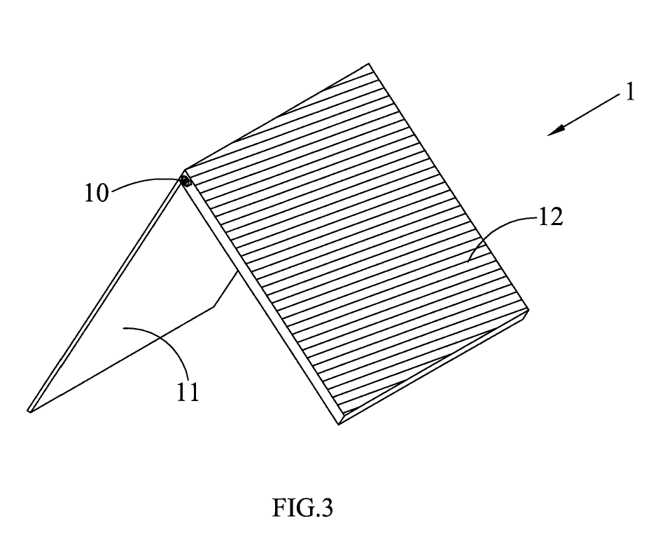

Referring to FIG. 1, a schematic view of a flip-cover apparatus according to the present invention is illustrated. In this figure, a flip-cover apparatus 1 comprises a cover 11, a body 12, and a shaft structure 10. The shaft structure 10 is connected to the body 12 and the cover 11, respectively. In this embodiment, the shaft structure 10 is disposed within one end of the body 12, which is taken as an example for explanation, but in another embodiment, the shaft structure 10 is disposed within one end of the cover 11. An apparatus, such as a screen, a minor, a keyboard, or the like, could be disposed on one face of the body 12. The cover 11 can be closed on the body 12 so as to achieve the effects of protection and scratch resistance when the device on the body 12 is not in use. In addition, referring to FIGS. 2 and 3, schematic views of a shaft structure according to the present invention are illustrated. In these figures, the shaft structure 10 comprises a housing 120 and a fixing part 110. The housing 120 comprises a braking part 1210 and a plurality of second protruding parts 1211. The fixing part 110 further comprises a plurality of first protruding parts 1110 and a plurality of concave parts 1120. In this embodiment, the housing 120 is disposed at one end of the cover 11 where the cover 11 is connected to the body 12 and is in a hollow cylindrical shape. The fixing part 110 is disposed within the housing 120, and one concave part 1120 is formed between two adjacent first protruding parts 1110. Moreover, the braking part 1210 extends in the direction from the housing 120 toward the fixing part 110, and is disposed around the fixing part 110. Each of the second protruding parts 1211 leans against to one of the concave parts 1120. The cross-section shape of the braking part 1210 is the shape of two bowls with their concave surfaces opposite each other, and each bowl wall is formed with one of the plurality of second protruding parts 1211.

When the housing 120 is rotated (either clockwise or counterclockwise) by turning the cover 11 over, the braking part 1210 will be driven by the housing 120 and rotated around the fixing part 110. The plurality of flexible second protruding parts 1211 of the braking part 1210 are crossed over the first protruding parts 1110 and lean against the adjacent concave parts 1120. The angle through which the braking part 1210 is rotated around the fixing part 110 is determined by the number of the first protruding parts 1110 of the fixing part 110 in conjunction with the size of the concaves of the braking parts 1210. As illustrated in FIG. 2, the number of the first protruding parts 1110 of the fixing part 110 is six, so the angle through which the braking part 1210 is rotated around the fixing part 110 by crossing each of the second protruding parts 1211 over one first protruding part 1110 is 60 degrees. Therefore, according to the shaft structure 10 of the present invention, different numbers of the first protruding parts 1110 of the fixing part 110 may be employed in combination with different sizes of the concaves of the braking part 1210, so that the housing 120 can be rotated through arbitrary angles around the fixing part 110 and then be immediately fixed. The difference between FIGS. 2 and 3 only lies in the shape of the first protruding parts 1110. The first protruding parts 1110 of a fixing part 110 in FIG. 2 are formed in a sharp corner shape so that the fixing part 110 is formed in a star shape. The first protruding parts 1110 of another fixing part 110 in FIG. 3 are formed in a semicircular arc shape so that the fixing part 110 is formed in a plum blossom shape.

Returning to FIG. 1, when the flip-cover apparatus 1 is used under strong light, the cover 11 can be flipped over by means of the shaft structure 10 of the present invention and fixed at a specific angle to achieve the effect of shielding strong light.

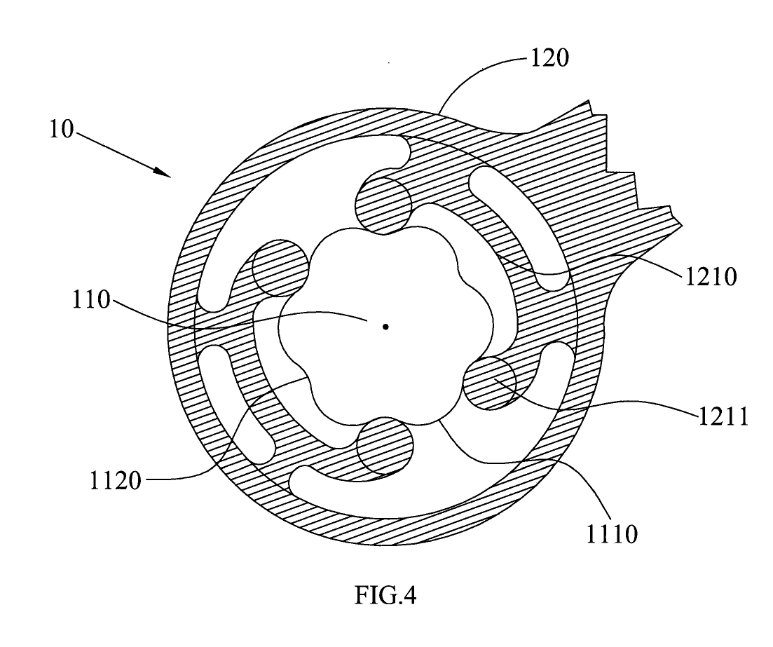

Referring to FIG. 4, a simulation diagram illustrating operation of a flip-cover apparatus according to the present invention is illustrated. In some cases, where the user cannot use the flip-cover apparatus 1 in a handheld manner, the cover 11 can be flipped over by means of the shaft structure 10 of the present invention and fixed at a specific angle (more than 180 degrees) such that the cover 11 can be used as a support.

The above description is illustrative only and is not to be considered limiting. Various modifications or changes can be made without departing from the spirit and scope of the invention. All such equivalent modifications and changes shall be included within the scope of the appended claims.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A shaft structure adapted for a flip-cover apparatus, comprising:
a fixing part being disposed in a housing and comprising a plurality of first protruding parts, wherein a plurality of concave parts are formed between any two adjacent first protruding parts; and
a braking part extending from the housing toward the fixing part and disposed around the fixing part, wherein the braking part has a plurality of second protruding parts, and each of the second protruding parts leans against one of the concave parts.

2. The shaft structure according to claim 1, wherein the number of the first protruding parts is more than or equal to the number of the second protruding parts.

3. The shaft structure according to claim 1, wherein the numbers of the first protruding parts and the concave parts are 6, respectively.

4. The shaft structure according to claim 1, wherein the cross-section of the first protruding parts is arranged in star-shape.

5. The shaft structure according to claim 1, wherein the cross-section of the first protruding parts is arranged in plum blossom-shape.

6. The shaft structure according to claim 1, wherein the cross-section shape between any two of the second protruding parts of the braking part is the shape of two bowls with their concaves opposite each other, and each bowl wall is formed with one of the plurality of second protruding parts.

7. The shaft structure according to claim 1, wherein the second protruding parts comprise elastic material.

8. The shaft structure according to claim 1, wherein the number of the second protruding parts is 4.

9. The shaft structure according to claim 1, wherein each of the second protruding parts of the braking part crosses over the first protruding part and leans against the adjacent concave part.

10. A flip-cover apparatus, comprising:
a body;
a cover; and
a shaft structure, comprising:
a housing;
a fixing part being disposed in the housing and comprising a plurality of first protruding parts, wherein a plurality of concave parts are formed between any two adjacent first protruding parts; and
a braking part extending from the housing toward the fixing part and disposed around the fixing part, wherein the braking part has a plurality of second protruding parts, and each of the second protruding parts leans against one of the concave parts when the body and the cover are in an open state.

11. The flip-cover apparatus according to claim 10, wherein the position of the body with respect to the braking part is fixed.

12. The flip-cover apparatus according to claim 10, wherein the flip-cover apparatus is an electronic book reader, a mobile phone, a minor, a personal digital assistant (PDA), a keyboard, or a navigator.

13. The flip-cover apparatus according to claim 10, wherein the number of the first protruding parts is more than or equal to the number of the second protruding parts.

14. The flip-cover apparatus according to claim 10, wherein the numbers of the first protruding parts and the concave parts are 6, respectively.

15. The flip-cover apparatus according to claim 10, wherein the cross-section of the first protruding parts is arranged in star-shaped.

16. The flip-cover apparatus according to claim 10, wherein the cross-section of the first protruding parts is arranged is plum blossom-shaped.

17. The flip-cover apparatus according to claim 10, wherein the cross-section shape between any two of the second protruding parts of the braking part is the shape of two bowls with their concaves opposite each other, and each bowl wall is formed with one of the plurality of second protruding parts.

18. The flip-cover apparatus according to claim 10, wherein the second protruding parts comprises elastic material.

19. The flip-cover apparatus according to claim 10, wherein the number of the second protruding parts is 4.

20. The flip-cover apparatus according to claim 10, wherein each of the second protruding parts of the braking part crosses over the first protruding part and leans against the adjacent concave part.
